(19) United States
(12) Patent Application Publication
(10) Pub. No.: US 2023/0166560 A1
(43) Pub. Date: Jun. 1, 2023

(54) Gate Roller Assembly

(71) Applicant: Roger Schroeder, Bryan, OH (US)

(72) Inventor: Roger Schroeder, Bryan, OH (US)

(21) Appl. No.: 17/538,017

(22) Filed: Nov. 30, 2021

(51) Int. Cl. B60B 33/00; E06B 11/02

(52) U.S. Cl. CPC B60B 33/0005; B60B 33/0018; E06B 11/022; B60B 2200/00

(57) ABSTRACT

A gate roller assembly includes a bracket that has a vertical portion and a horizontal portion. The vertical portion is positioned against a gate having the horizontal portion extending away from the gate. A plurality of bolts is provided and each of the bolts extends through the vertical portion of the bracket to engage the gate for retaining the bracket on the gate. A plurality of nuts is provided and each of the nuts threadably engages a respective one of the bolts for retaining the first plate on the gate. A roller is rotatably disposed on the horizontal portion of the bracket to roll along the support surface when the gate is opened or closed.

### CROSS-REFERENCE TO RELATED APPLICATIONS

Not Applicable

### STATEMENT REGARDING FEDERALLY SPONSORED RESEARCH OR DEVELOPMENT

Not Applicable

### THE NAMES OF THE PARTIES TO A JOINT RESEARCH AGREEMENT

Not Applicable

### INCORPORATION-BY-REFERENCE OF MATERIAL SUBMITTED ON A COMPACT DISC OR AS A TEXT FILE VIA THE OFFICE ELECTRONIC FILING SYSTEM

Not Applicable

### STATEMENT REGARDING PRIOR DISCLOSURES BY THE INVENTOR OR JOINT INVENTOR

Not Applicable

### BACKGROUND OF THE INVENTION

### (1) Field of the Invention

The disclosure relates to roller devices and more particularly pertains to a new roller device for enhancing opening and closing a gate. The device includes a bracket that has a horizontal portion and a vertical portion and a roller that is rotatably disposed on the horizontal portion. The vertical portion is retained on a gate with a plurality of J-shaped bolts such that the roller engages a support surface. In this way the roller rolls along the support surface when the gate is opened and closed.

### (2) Description of Related Art Including Information Disclosed Under 37 CFR 1.97 and 1.98

The prior art relates to roller devices including a roller that is attachable to a bottom surface of a wooden gate. The prior art discloses a self aligning gate device that includes hinges that bias a gate into a closed position and a roller that is disposed on the gate. The prior art discloses a gate wheel device that includes a shaft which is attached to a free edge of a gate and a wheel that is rotatably disposed on the shaft. The prior art discloses a gate roller device that includes a plurality of u-bolts that are positioned on opposite sides of a gate and a roller that is rotatably disposed on distal ends of the u-bolts. The prior art discloses a ladder roller device that includes a bracket which engages a leg of a ladder and a roller that is rotatably disposed on the bracket for rolling along a support surface when the ladder is being carried.

### BRIEF SUMMARY OF THE INVENTION

An embodiment of the disclosure meets the needs presented above by generally comprising a bracket that has a vertical portion and a horizontal portion. The vertical portion is positioned against a gate having the horizontal portion extending away from the gate. A plurality of bolts is provided and each of the bolts extends through the vertical portion of the bracket to engage the gate for retaining the bracket on the gate. A plurality of nuts is provided and each of the nuts threadably engages a respective one of the bolts for retaining the first plate on the gate. A roller is rotatably disposed on the horizontal portion of the bracket to roll along the support surface when the gate is opened or closed.

There has thus been outlined, rather broadly, the more important features of the disclosure in order that the detailed description thereof that follows may be better understood, and in order that the present contribution to the art may be better appreciated. There are additional features of the disclosure that will be described hereinafter and which will form the subject matter of the claims appended hereto.

The objects of the disclosure, along with the various features of novelty which characterize the disclosure, are pointed out with particularity in the claims annexed to and forming a part of this disclosure.

### BRIEF DESCRIPTION OF SEVERAL VIEWS OF THE DRAWING(S)

The disclosure will be better understood and objects other than those set forth above will become apparent when consideration is given to the following detailed description thereof. Such description makes reference to the annexed drawings wherein:

FIG. 1 is a perspective view of a gate roller assembly according to an embodiment of the disclosure.

FIG. 2 is a bottom view of an embodiment of the disclosure.

FIG. 3 is a back view of an embodiment of the disclosure.

FIG. 4 is a right side phantom view of an embodiment of the disclosure.

FIG. 5 is a front view of an embodiment of the disclosure.

FIG. 6 is a perspective in-use view of an embodiment of the disclosure.

### DETAILED DESCRIPTION OF THE INVENTION

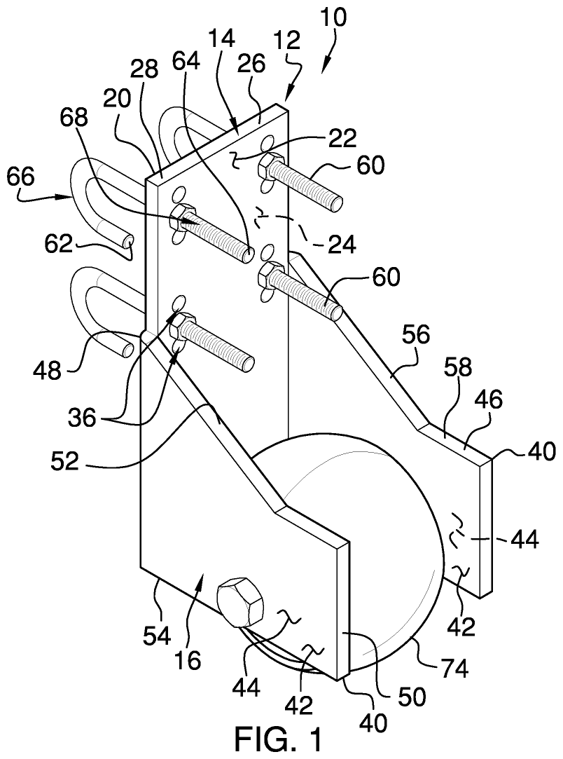

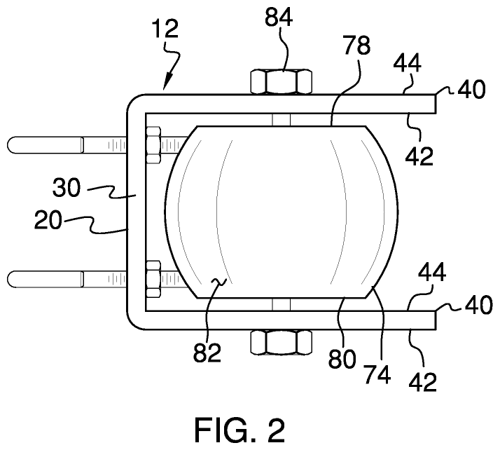

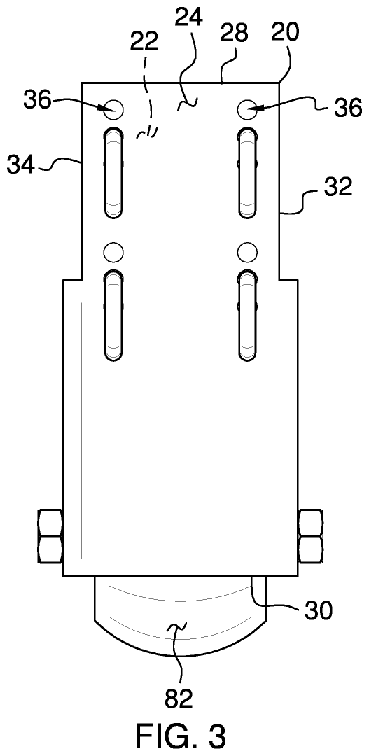

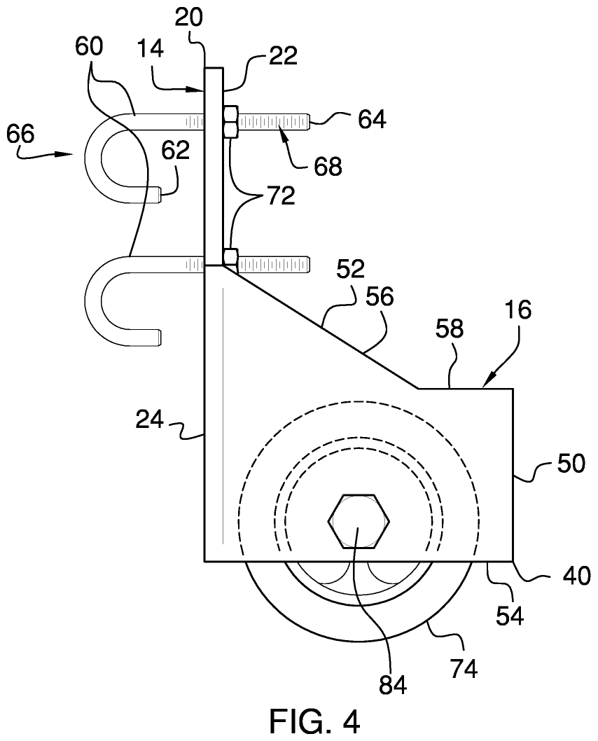

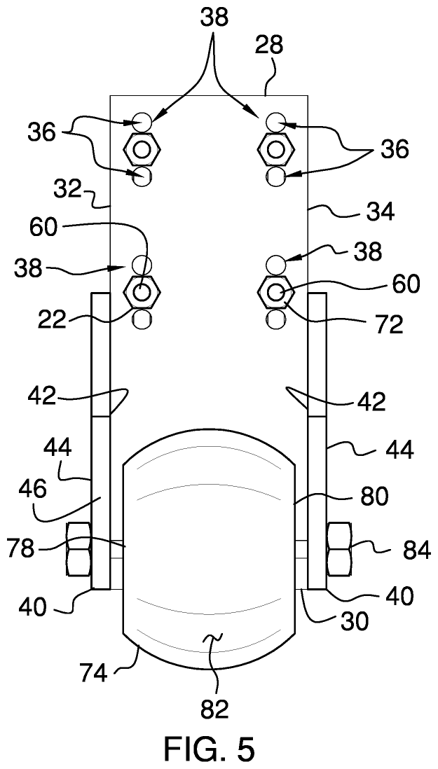

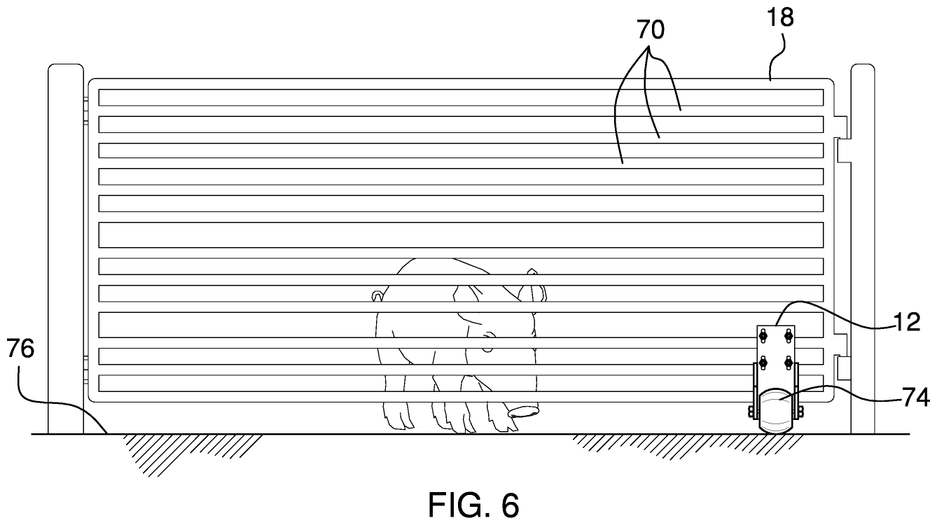

With reference now to the drawings, and in particular to FIGS. 1 through 6 thereof, a new roller device embodying the principles and concepts of an embodiment of the disclosure and generally designated by the reference numeral 10 will be described.

As best illustrated in FIGS. 1 through 6, the gate roller assembly 10 generally comprises a bracket 12 that has a vertical portion 14 and a horizontal portion 16. The vertical portion 14 is positioned against a gate 18 having the horizontal portion 16 extending away from the gate 18. The gate 18 may be a livestock gate in a livestock pen which has a concrete floor. The vertical portion 14 comprises a first plate 20 has a front surface 22, a back surface 24 and a perimeter edge 26 extending between the front surface 22 and the back surface 24, and the perimeter edge 26 has a top side 28, a bottom side 30, a first lateral side 32 and a second lateral side 34.

The first plate 20 is elongated between the top side 28 and the bottom side 30, and the first plate 20 has a plurality of holes 36 each extending through the front surface 22 and the back surface 24. The plurality of holes 36 is spaced apart from each other and is distributed along an axis extending between the top side 28 and the bottom side 30. The plurality of holes 36 is arranged into a plurality of sets of the holes 38 and each of the sets of holes 38 are positioned adjacent to a respective one of the first lateral side 32 and the second lateral side 34. Furthermore, the sets of holes 38 are spaced apart from each other and are distributed along the axis extending between the top side 28 and the bottom side 30.

The horizontal portion 16 includes a pair of second plates 40 and each of the second plates 40 has a first lateral surface 42, a second lateral surface 44 and an exterior edge 46 extending between the first lateral surface 42 and the second lateral surface 44. The exterior edge 46 has a rear side 48, a front side 50, an upper side 52 and a lower side 54, and the upper side 52 of the exterior edge 46 of each of the second plates 40 has an angled portion 56 and a straight portion 58. The angled portion 56 angles downwardly between the upper side 52 and the straight portion 58. Moreover, the straight portion 58 extends between the angled portion 56 and the front side 50 such that the rear side 48 has a length that is greater than the front side 50.

The rear side 48 of each of the second plates 40 is coupled to a respective one of the first lateral side 32 and the second lateral side 34 of the perimeter edge 26 of the first plate 20. The first lateral surface 42 of a respective one of the second plates 40 faces the second lateral side 34 of a respective one of the second plates 40. Additionally, each of the second plates 40 extends away from the front surface 22 of the first plate 20. The lower side 54 of the exterior edge 46 of each of the second plates 40 is aligned with the bottom side 30 of the perimeter edge 26 of the first plate 20.

A plurality of bolts 60 is provided and each of the bolts 60 extends through the vertical portion 14 of the bracket 12. Each of the bolts 60 engages the gate 18 for retaining the bracket 12 on the gate 18. Each of the bolts 60 has a first end 62 and a second end 64, and each of the bolts 60 has a curve 66 that is positioned closer to the first end 62 than the second end 64 such that each of the bolts 60 has a J-shape. Each of the bolts 60 has a threaded portion 68 extending from the second end 64 toward the first end 62.

Each of the bolts 60 is extendable through a respective one of a respective one of the sets of holes 38 in the first plate 20 having the second end 64 being spaced from the front surface 22 of the first plate 20. Furthermore, the curve 66 on each of the bolts 60 engages a respective one of a plurality of horizontal members 70 of the gate 18 having the back surface 24 of the plate abutting the horizontal members 70. A plurality of nuts 72 each threadably engages a respective one of the bolts 60 for retaining the first plate 20 on the gate 18. Each of the nuts 72 threadably engages the threaded portion 68 of the respective bolt having the nuts 72 engaging the front surface 22 of the first plate 20 thereby drawing the curve 66 in each of the bolts 60 toward the back surface 24 of the first plate 20.

A roller 74 is provided and the roller 74 is rotatably disposed on the horizontal portion 16 of the bracket 12. In this way the roller 74 can roll along a support surface 76, which may comprise the concrete floor of the livestock pen, when the gate 18 is opened or closed. Thus, the roller 74 enhances opening and closing the gate 18 and the roller 74 inhibits the gate 18 from damaging the concrete floor of the livestock pen. The roller 74 has a first sidelong surface 78, a second sidelong surface 80 and an outer surface 82 extending between the first sidelong surface 78 and the second sidelong surface 80.

The outer surface 82 is continuously arcuate about an axis extending between the first sidelong surface 78 and the second sidelong surface 80. In this way the outer surface 82 can roll along the support surface 76. The roller 74 is positioned between each of the second plates 40. The first sidelong surface 78 faces the first lateral surface 42 of a respective one of the second plates 40. Furthermore, the second sidelong surface 80 faces the second lateral surface 44 of a respective one of the second plates 40. An axle 84 extends through each of the second plates 40 and extends through each of the first sidelong surface 78 and the second sidelong surface 80 of the roller 74 such that the roller 74 is rotatably retained on the second plates 40. The axle 84 may comprise a nut and bolt or other type of elongated member around which the roller 74 can rotate.

In use, each of the bolts 60 is attached to respective horizontal members 70 of the gate 18 such that the bracket 12 is positioned adjacent to a bottom 86 of the gate 18. In this way the roller 74 can rotatably engage the support surface 76. Thus, the roller 74 rolls along the support surface 76 when the gate 18 is opened and closed. In this way the roller 74 reduces the effort required to open and close the gate 18. Additionally, the roller 74 inhibits the gate 18 from damaging the support surface 76 that would result from the gate 18 frictionally engaging the support surface 76.

With respect to the above description then, it is to be realized that the optimum dimensional relationships for the parts of an embodiment enabled by the disclosure, to include variations in size, materials, shape, form, function and manner of operation, assembly and use, are deemed readily apparent and obvious to one skilled in the art, and all equivalent relationships to those illustrated in the drawings and described in the specification are intended to be encompassed by an embodiment of the disclosure.

Therefore, the foregoing is considered as illustrative only of the principles of the disclosure. Further, since numerous modifications and changes will readily occur to those skilled in the art, it is not desired to limit the disclosure to the exact construction and operation shown and described, and accordingly, all suitable modifications and equivalents may be resorted to, falling within the scope of the disclosure. In this patent document, the word “comprising” is used in its non-limiting sense to mean that items following the word are included, but items not specifically mentioned are not excluded. A reference to an element by the indefinite article “a” does not exclude the possibility that more than one of the element is present, unless the context clearly requires that there be only one of the elements.

1. A gate roller assembly for facilitating a gate to roll along a support surface for opening and closing the gate, said assembly comprising:
a bracket having a vertical portion and a horizontal portion wherein said vertical portion is configured to be positioned against a gate having said horizontal portion extending away from the gate;
a plurality of bolts, each of said bolts extending through said vertical portion of said bracket wherein each of said bolts is configured to engage the gate for retaining said bracket on the gate;
a plurality of nuts, each of said nuts threadably engaging a respective one of said bolts for retaining said first plate on the gate; and
a roller being rotatably disposed on said horizontal portion of said bracket such that said roller is fully offset from said vertical portion of said bracket wherein said roller is configured to roll along the support surface when the gate is opened or closed.

2. The assembly according to claim 1, wherein:
said vertical portion comprises a first plate having a front surface, a back surface and a perimeter edge extending between said front surface and said back surface, said perimeter edge having a top side, a bottom side, a first lateral side and a second lateral side, said first plate being elongated between said top side and said bottom side; and
said first plate has a plurality of holes each extending through said front surface and said back surface, said plurality of holes being spaced apart from each other and being distributed along an axis extending between said top side and said bottom side, said plurality of holes being arranged into a plurality of sets of said holes, each of said sets of holes being positioned adjacent to a respective One of said first lateral side and said second lateral side, said sets of holes being spaced apart from each other and being distributed along said axis extending between said top side and said bottom side.

3. The assembly according to claim 1, wherein:
said vertical portion includes a first plate; and
said horizontal portion includes a pair of second plates, each of said second plates having a first lateral surface, a second lateral surface and an exterior edge extending between said first lateral surface and said second lateral surface, said exterior edge having a rear side, a front side, an upper side and a lower side, said upper side of said exterior edge of each of said second plates having an angled portion and a straight portion, said angled portion angling downwardly between said upper side and said straight portion, said straight portion extending between said angled portion and said front side such that said rear side has a length being greater than said front side.

4. The assembly according to claim 3, wherein:
said first plate has a perimeter edge and a front surface, said perimeter edge having a first lateral side, a second lateral side and a bottom side; and
said rear side of each of said second plates is coupled to a respective one of said first lateral side and said second lateral side of said perimeter edge of said first plate having said first lateral surface of a respective one of said second plates facing said second lateral side of a respective one of said second plates, each of said second plates extending away from said front surface of said first plate, said lower side of said exterior edge of each of said second plates being aligned with said bottom side of said perimeter edge of said first plate.

5. The assembly according to claim 2, wherein each of said bolts has a first end and a second end, each of said bolts having a curve being positioned closer to said first end than said second end such that each of said bolts has a J-shape, each of said bolts having a threaded portion extending from said second end toward said first end, each of said bolts being extendable through a respective one of said sets of holes in said first plate having said second end being spaced from said front surface of said first plate wherein said curve on each of said bolts is configured to engage a respective one of a plurality of horizontal members of the gate having said back surface of said plate abutting the horizontal members.

6. The assembly according to claim 5, wherein each of said nuts threadably engages said threaded portion of said respective bolt having said nuts engaging said front surface of said first plate thereby drawing said curve in each of said bolts toward said back surface of said first plate.

7. The assembly according to claim 3, wherein said roller has a first sidelong surface, a second sidelong surface and an outer surface extending between said first sidelong surface and said second sidelong surface, said outer surface being continuously arcuate about an axis extending between said first sidelong surface and said second sidelong surface wherein said outer surface is configured to roll along the support surface, said roller being positioned between each of said second plates, said first sidelong surface facing said first lateral surface of a respective one of said second plates, said second sidelong surface facing said second lateral surface of a respective one of said second plates.

8. The assembly according to claim 7, further comprising an axle extending through each of said second plates and extending through each of said first sidelong surface and said second sidelong surface of said roller such that said roller is rotatably retained on said second plates.

9. A gate roller assembly for facilitating a gate to roll along a support surface for opening and closing the gate, said assembly comprising:
a bracket having a vertical portion and a horizontal portion wherein said vertical portion is configured to be positioned against a gate having said horizontal portion extending away from the gate, said vertical portion comprising a first plate having a front surface, a back surface and a perimeter edge extending between said front surface and said back surface, said perimeter edge having a top side, a bottom side, a first lateral side and a second lateral side, said first plate being elongated between said top side and said bottom side, said first plate having a plurality of holes each extending through said front surface and said back surface, said plurality of holes being spaced apart from each other and being distributed along an axis extending between said top side and said bottom side, said plurality of holes being arranged into a plurality of sets of said holes, each of said sets of holes being positioned adjacent to a respective one of said first lateral side and said second lateral side, said sets of holes being spaced apart from each other and being distributed along said axis extending between said top side and said bottom side, said horizontal portion including a pair of second plates, each of said second plates having a first lateral surface, a second lateral surface and an exterior edge extending between said first lateral surface and said second lateral surface, said exterior edge having a rear side, a front side, an upper side and a lower side, said upper side of said exterior edge of each of said second plates having an angled portion and a straight portion, said angled portion angling downwardly between said upper side and said straight portion, said straight portion extending between said angled portion and said front side such that said rear side has a length being greater than said front side, said rear side of each of said second plates being coupled to a respective one of said first lateral side and said second lateral side of said perimeter edge of said first plate having said first lateral surface of a respective one of said second plates facing said second lateral side of a respective one of said second plates, each of said second plates extending away from said front surface of said first plate, said lower side of said exterior edge of each of said second plates being aligned with said bottom side of said perimeter edge of said first plate;
a plurality of bolts, each of said bolts extending through said vertical portion of said bracket wherein each of said bolts is configured to engage the gate for retaining said bracket on the gate, each of said bolts having a first end and a second end, each of said bolts having a curve being positioned closer to said first end than said second end such that each of said bolts has a J-shape, each of said bolts having a threaded portion extending from said second end toward said first end, each of said bolts being extendable through a respective one of said sets of holes in said first plate having said second end being spaced from said front surface of said first plate wherein said curve on each of said bolts is configured to engage a respective one of a plurality of horizontal members of the gate having said back surface of said plate abutting the horizontal members;
a plurality of nuts, each of said nuts threadably engaging a respective one of said bolts for retaining said first plate on the gate, each of said nuts threadably engaging said threaded portion of said respective bolt having said nuts engaging said front surface of said first plate thereby drawing said curve in each of said bolts toward said back surface of said first plate;
a roller being rotatably disposed on said horizontal portion of said bracket such that said roller is fully offset from said vertical portion of said bracket wherein said roller is configured to roll along the support surface when the gate is opened or closed, said roller having a first sidelong surface, a second sidelong surface and an outer surface extending between said first sidelong surface and said second sidelong surface, said outer surface being continuously arcuate about an axis extending between said first sidelong surface and said second sidelong surface wherein said outer surface is configured to roll along the support surface, said roller being positioned between each of said second plates, said first sidelong surface facing said first lateral surface of a respective one of said second plates, said second sidelong surface facing said second lateral surface of a respective one of said second plates; and
an axle extending through each of said second plates and extending through each of said first sidelong surface and said second sidelong surface of said roller such that said roller is rotatably retained on said second plates.
